(19) United States
(12) Patent Application Publication
(10) Pub. No.: US 2025/0091064 A1
(43) Pub. Date: Mar. 20, 2025

(54) ROTARY ATOMIZING HEAD TYPE COATING MACHINE

(71) Applicant: ABB SCHWEIZ AG, Baden (CH)

(72) Inventor: Masaru Terada, Tokyo (JP)

(21) Appl. No.: 18/884,435

(22) Filed: Sep. 13, 2024

(30) Foreign Application Priority Data
Sep. 14, 2023 (JP) 2023-148983

(51) Int. Cl. B05B 5/04

(52) U.S. Cl. CPC B05B 5/0407; B05B 5/0426

(57) ABSTRACT

A cylindrical shaping air ring provided on an outer periphery of a rotary atomizing head, includes an overhanging portion as an isolation means for isolating a second shaping air jetting unit from the air flowing around the shaping air ring.

### TECHNICAL FIELD

The present invention relates to a rotary atomizing head type coating machine suitable for use in coating objects such as automobile bodies.

### BACKGROUND ART

In general, when painting the body of an automobile as an object to be painted, a rotary atomizing head type paint sprayer is used because it has good coating efficiency and paint finish. This rotary atomizing head type coating machine comprises an air motor powered by compressed air, a hollow rotating shaft supported for free rotation while extending in the front-to-back direction along the axis of the air motor with its front part protruding from the air motor, a feed tube extending through the rotating shaft to the front part of the rotating shaft, a cup-shaped rotary atomizing head attached to the front part of the rotating shaft and discharging paint supplied from the feed tube from the discharge edge at the front end, a cylindrical shaping air ring provided on the outer periphery of the rotary atomizing head, and a shaping air ejection section provided in front of the shaping air ring and ejecting shaping air toward the paint discharged from the discharge edge of the rotary atomizing head (Patent Literature 1).

In coating with a rotary atomizing head type coating machine, shaping air is ejected from the shaping air ejection section to shape the paint particles sprayed from the rotary atomizing head into a spray pattern that provides a uniform coating thickness distribution.

### PRIOR ART LITERATURE

### Patent Literature

[Patent Literature 1] Japanese Examined Patent Application Publication No. 6614757

### SUMMARY OF THE INVENTION

### Problem to be Solved by the Invention

When painting is performed using the rotary atomizing head type coating machine of Patent Literature 1, some of the paint particles sprayed from the rotary atomizing head that do not adhere to the workpiece float around the shaping air ring. In addition, during painting, as described above, shaping air is ejected from the shaping air ejection section. In this case, the shaping air ejected forward also moves the paint floating in the air around the shaping air ring to the front side. This causes floating paint to adhere and accumulate on the front portion of the shaping air ring. In this way, if paint accumulates on the shaping air ring, there is a risk that the paint peeled off by the shaping air will adhere to the coating surface together with the sprayed paint, causing poor quality.

On the other hand, in order to prevent quality defects, it is necessary to set aside time to periodically clean the sprayer even while the production line is in operation. In addition, quality defects can be reduced by shortening the intervals between cleaning of the sprayer or by lengthening the cleaning time itself, but this leads to increased cleaning costs and reduced productivity.

Another possible solution is to provide an automatic cleaning device for the sprayer, and use the automatic cleaning device to clean the shaping air ring located at the tip of the sprayer after one or several coating sessions. However, the installation of an automatic cleaning device increases the cost and increases the amount of thinner used for cleaning.

The present invention has been made in consideration of the problems with the prior art described above, and an object of the present invention is to provide a rotary atomizing head type sprayer which suppresses contamination of the front portion of the shaping air ring, thereby making it possible to eliminate cleaning work, improving productivity and reducing the cost required for cleaning.

### Means for Solving the Problem

The present invention relates to a rotary atomizing head type coating machine comprising: an air motor using compressed air as a power source; a hollow rotating shaft supported rotatably while extending in a front-rear direction along the axis of the air motor, with a front unit protruding from the air motor; a feed tube extending through the inside of the rotating shaft to the front unit of the rotating shaft; a cup-shaped rotary atomizing head attached to the front unit of the rotating shaft and discharging paint supplied from the feed tube from a discharge edge at the front end; a cylindrical shaping air ring provided on the outer periphery of the rotary atomizing head; and a shaping air jetting unit provided in front of the shaping air ring and jetting shaping air toward the paint discharged from the discharge edge of the rotary atomizing head, wherein the shaping air ring is provided with an isolation means for isolating the shaping air jetting unit from the air flowing around the shaping air ring.

### Effects of the Invention

According to the present invention, it is possible to suppress contamination of the front portion of the shaping air ring, and it is possible to omit the cleaning work, thereby improving productivity and reducing the cost required for cleaning.

### BRIEF DESCRIPTION OF THE DRAWINGS

FIG. 1 This is a cross-sectional view showing a rotary atomizing head type coating machine according to the first embodiment of the present invention.

FIG. 2 This is an enlarged cross-sectional view showing a main part in FIG. 1.

FIG. 3 This is a cross-sectional view showing a rotary atomizing head type coating machine according to the second embodiment of the present invention.

FIG. 4 This is a cross-sectional view showing a rotary atomizing head type coating machine according to the third embodiment of the present invention.

### DETAILED DESCRIPTION OF THE EMBODIMENTS

A rotary atomizing head type coating machine according to an embodiment of the present invention will now be described in detail with reference to the accompanying drawings.

There are two types of rotary atomizing head type coating machines: electrostatic coating machines that apply a coating by applying high voltage to the coating material to be atomized, and non-electrostatic coating machines that apply a coating without applying high voltage to the coating material. In the example of embodiment to be described hereinafter, a rotary atomizing head-type sprayer that has been constructed as a direct-charging electrostatic coating machine that directly applies high voltage to the coating material will be described as an example. Even when applied to a non-electrostatic sprayer, the effect of suppressing the flow of floating paint can be obtained.

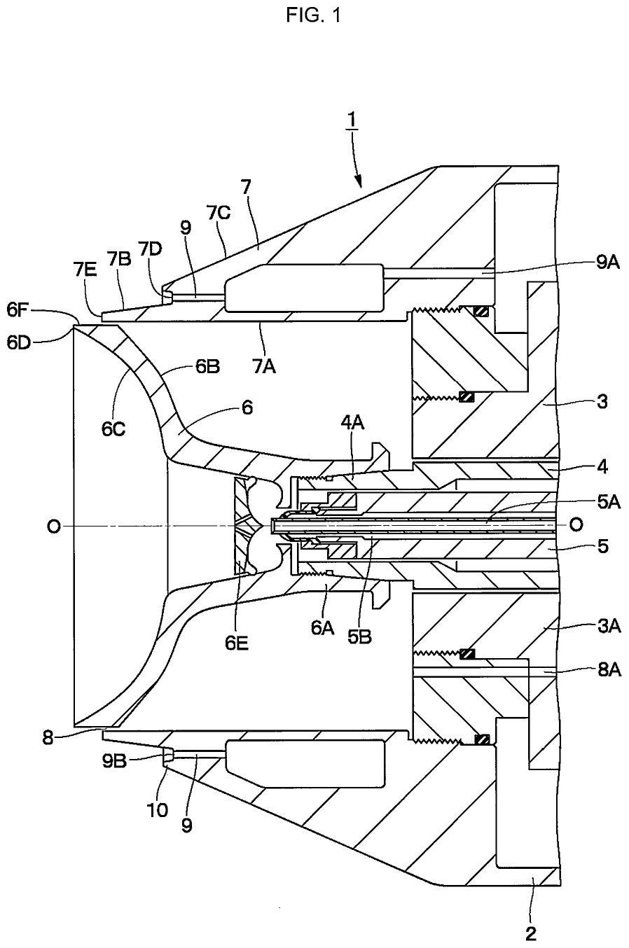

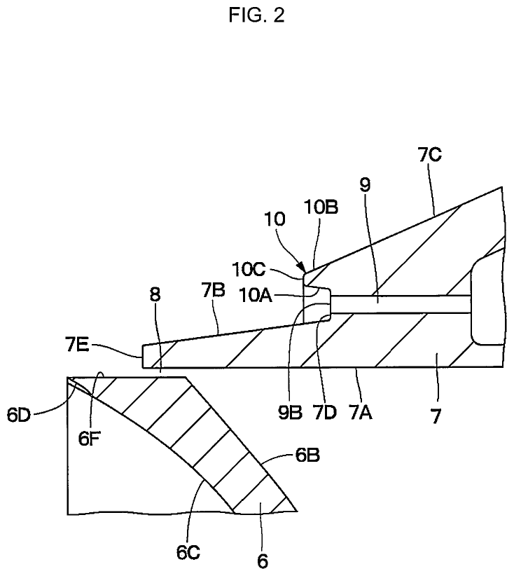

FIGS. 1 and 2 show the first embodiment of the present invention. In FIG. 1, the rotary atomizing head type coating machine 1 according to an embodiment of the present invention is configured as a direct charging type electrostatic sprayer in which a high voltage is directly applied to paint by a high voltage generator (not shown). The rotary atomizing head type coating machine 1 is attached, for example, to the tip of an arm (not shown) of a painting robot. The rotary atomizing head type coating machine 1 includes a housing 2, an air motor 3, a rotary shaft 4, a feed tube 5, a rotary atomizing head 6, a shaping air ring 7, a first shaping air jetting unit 8, and a second shaping air jetting unit 9, which will be described later.

The housing 2 is formed as a cylindrical body and is attached to the tip of an arm of a painting robot. A motor accommodating unit (not shown) for accommodating the air motor 3 is formed on the inner circumferential side of the housing 2 and opens toward the front. Here, the motor accommodating unit is formed of a circular stepped hole having an axis extending in the front-rear direction at its center.◯◯ This axis serves as the central axis around which the air motor 3, the rotary shaft 4, and the rotary atomizing head 6 rotate.◯◯ Furthermore, a shaping air ring 7 is provided on the front side of the housing 2.

The air motor 3 is mounted axially within the housing 2.◯◯ The air motor 3 uses compressed air as a power source to rotate the rotary shaft 4 and the rotary atomizing head 6 at a high speed of, for example, 3 k to 150 k rpm. The air motor 3 comprises a stepped cylindrical motor case 3A attached to the motor accommodating section of the housing 2, a turbine (not shown) rotatably mounted on the rear side of the motor case 3A, and an air bearing (not shown) mounted on the motor case 3A and rotatably supporting the rotary shaft 4. The rotation speed of the turbine changes according to the flow rate of the turbine air supplied. That is, the rotation speed of the rotary atomizing head 6 is controlled by the turbine.

The rotary shaft 4 extends in the front-rear direction coaxially with the axis of the air motor 3 and is rotatably supported via an air bearing.◯◯ The rotary shaft 4 is formed as a hollow cylinder, with its rear unit integrally attached to the center of the turbine and its front unit 4A protruding from the motor case 3A. A rotary atomizing head 6 is attached to the front unit 4A of the rotary shaft 4.

The feed tube 5 passes through the rotating shaft 4 and extends to a front unit 4A of the rotary shaft 4. The front side of the feed tube 5 protrudes from the front unit 4 A of the rotary shaft 4 and extends into the rotary atomizing head 6. The rear end side of the feed tube 5 is fixedly attached to the center position of the housing 2.

The feed tube 5 is formed as a double tube arranged coaxially. The central flow path of this double pipe serves as a paint flow path 5A, and the outer annular flow path serves as a cleaning fluid flow path 5B. The paint flow path 5A and the cleaning fluid flow path 5B are connected to supply sources (not shown) of paint and cleaning fluid (thinner, air, etc.), respectively. As a result, the feed tube 5 supplies paint from the paint flow path 5A toward the rotary atomizing head 6 when performing a painting operation. On the other hand, the feed tube 5 supplies the cleaning fluid from the cleaning fluid flow path 5B toward the rotary atomizing head 6 when performing the work of cleaning off the adhering paint. Moreover, the feed tube may be configured so that one flow path can be switched for use with both the paint and the cleaning fluid.

The rotary atomizing head 6 atomizes and sprays the paint supplied from the feed tube 5. The rotary atomizing head 6 has a rear attachment unit 6A attached to the front unit 4A of the rotary shaft 4. The rotary atomizing head 6 is rotated at high speed together with the rotary shaft 4 by the air motor 3.

The rotary atomizing head 6 has an outer peripheral surface 6B that expands forward from the mounting unit 6A into a cup shape, and an inner peripheral surface 6C that expands forward into a funnel shape to form a paint thinning surface that spreads the paint supplied from the feed tube 5 while thinning it into a thin film. The front end of the inner circumferential surface 6C is formed as a discharge edge 6D that discharges the paint diffused by the inner circumferential surface 6C when the rotary atomizing head 6 rotates.

On the other hand, inside the rotary atomizing head 6, a disk-shaped hub member 6E is provided at the back of the inner circumferential surface 6C (closer to the mounting unit 6A). This hub member 6E can smoothly guide the paint supplied from the feed tube 5 to the inner circumferential surface 6C. Furthermore, a front unit 6F of the outer circumferential surface 6B of the rotary atomizing head 6 on the side of the discharging edge 6D faces a front unit of an inner cylindrical surface 7A of a shaping air ring 7 described later in the radial direction.

Here, the rotary atomizing head 6 is rotated at high speed by the air motor 3 and paint is supplied from the feed tube 5. As a result, the rotary atomizing head 6 spreads the paint while thinning it on the inner circumferential surface 6C (paint thinning surface), and sprays it from the discharge edge 6D as countless fine paint particles due to centrifugal force.

The shaping air ring 7 is provided on the outer periphery of the rotary atomizing head 6. The shaping air ring 7 is formed in a stepped cylindrical shape using a conductive material such as metal, and is provided on the front side of the housing 2 so as to surround the rotary atomizing head 6. The shaping air ring 7 made of a conductive material makes it difficult for paint to adhere due to electrostatic repulsion, and together with the effect of the overhanging unit 10 described below, it is possible to suppress the adhesion of paint particles.

As shown in FIG. 2, the shaping air ring 7 has an inner cylinder surface 7A, a front outer cylinder surface 7B located on the front side, a rear outer cylinder surface 7C located on the rear side, a step unit 7D between the front outer cylinder surface 7B and the rear outer cylinder surface 7C, and a front end unit 7E located at the frontmost unit. The front unit of the inner cylindrical surface 7A overlaps with the front unit 6F of the outer circumferential surface 6B of the rotary atomizing head 6 with a gap therebetween. As a result, the first shaping air jetting unit 8, which will be described later, is formed between the outer circumferential surface 6B and the inner cylindrical surface 7A.

Further, the step unit 7D is disposed in front of the shaping air ring 7. The step unit 7D is formed, for example, as an annular plane perpendicular to the axis.◯◯ The step unit 7D is provided with an overhanging portion 10 (described later) at a position surrounding the second shaping air jetting unit 9 (described later), specifically, at the outermost periphery continuing to the rear outer cylinder surface 7C.

The first shaping air jetting unit 8 is provided on the outer circumferential side of the rotary atomizing head 6. The first shaping air jetting unit 8 jets first shaping air toward the paint discharged from the discharge edge 6D. The first shaping air jetting unit 8 is formed as an annular gap between the outer circumferential surface 6B (front unit 6F) of the rotary atomizing head 6 and the inner cylindrical surface 7A of the shaping air ring 7. As a result, the first shaping air jetting unit 8 is in a state where there is no obstacle in front of it, so that the first shaping air can be jetted stably. The first shaping air jetting unit 8 is connected to an air supply source (not shown) via a first shaping air supply passage 8A and the like.

The second shaping air jetting unit 9 serving as a shaping air jetting unit is provided in front of the shaping air ring 7. The second shaping air jetting unit 9 is disposed radially outward of the first shaping air jetting part 8 and surrounds the rotary atomizing head 6. The second shaping air jetting unit 9 jets out second shaping air toward the paint discharged from the discharge edge 6D of the rotary atomizing head 6, similarly to the first shaping air jetting unit 8.

The second shaping air jetting unit 9 is formed by a large number of holes that open in the step unit 7D of the shaping air ring 7 and are aligned in the circumferential direction. The second shaping air jetting unit 9 is connected to an air supply source (not shown) via a second shaping air supply path 9A and the like. It is also possible to eliminate the first shaping air jetting unit 8 and to configure so that shaping air is jetted only from the second shaping air jetting unit 9.

Next, the configuration, function, etc. of the overhanging portion 10, which is a characteristic portion of this embodiment, will be described in detail with reference to FIG. 2.

The overhanging portion 10 serving as an isolating means is provided in front of the shaping air ring 7 so as to surround the second shaping air jetting unit 9. Specifically, the overhanging portion 10 is formed in a cylindrical shape extending forward beyond the open end 9B of the second shaping air jetting unit 9 on the outermost periphery of the step unit 7D located in front of the shaping air ring 7. The overhanging portion 10 isolates the second shaping air jetting unit 9 from the air flowing around the shaping air ring 7.

The overhanging portion 10 is formed into a triangular or trapezoidal cross-section by an inner circumferential surface 10A that expands in diameter toward the front, an outer circumferential surface 10B that contracts in diameter toward the front, and a tip edge 10C that connects the inner circumferential surface 10A and the outer circumferential surface 10B. In a structure in which the inner circumferential surface 10A expands in diameter toward the front side, the second shaping air ejected from the second shaping air ejection unit 9 can be ejected straight without being pulled toward the inner circumferential surface 10A. In addition, the outer circumferential surface 10B, which decreases in diameter toward the front side, continues to the front side of the rear outer cylindrical surface 7C without any step. The tip edge 10C may be formed in a ridge shape instead of a flat surface.

Here, since the overhanging portion 10 is provided in front of the shaping air ring 7 so as to surround the second shaping air jetting unit 9, the second shaping air jetting unit 9 is isolated from the air convecting to the shaping air ring 7. Therefore, the overhanging portion 10 can prevent the paint particles floating around the shaping air ring 7 from being drawn into the second shaping air jetting unit 9 side.

The rotary atomizing head type coating machine 1 according to the present embodiment has the above-mentioned configuration. Next, the operation when performing a painting operation using this rotary atomizing head type coating machine 1 will be explained.

First, turbine air is supplied to the turbine of the air motor 3, and the air motor 3 rotates the rotary shaft 4 and the rotary atomizing head 6 at high speed. In this state, paint is supplied from the paint supply source to the rotary atomizing head 6 through the paint flow path 5A of the feed tube 5. As a result, the rotary atomizing head 6 sprays the supplied paint as paint particles.

In this case, the rotary atomizing head 6 is connected to a high voltage generator via the air motor 3, the rotary shaft 4, etc., so that the paint flowing on the surface of the rotary atomizing head 6 is applied with a high voltage. As a result, the paint particles sprayed from the rotary atomizing head 6, i.e., the charged paint particles, fly toward the object to be painted, such as an automobile body connected to earth, and are deposited on the painted surface.

On the other hand, the paint particles discharged from the discharge edge 6D of the rotary atomizing head 6 are sprayed from the rear by the first shaping air ejected from the first shaping air jetting unit 8 and the second shaping air ejected from the second shaping air jetting unit 9, thereby enabling the spray pattern to be well shaped.

Here, among the paint particles sprayed from the rotary atomizing head 6, some of the paint particles that do not adhere to the object to be coated float around the shaping air ring 7. In addition, the shaping air ejected forward also moves the paint suspended together with the air around the shaping air ring 7 to the front side of the shaping air ring 7. As a result, there is a risk that floating paint will adhere and accumulate on the front portion of the shaping air ring 7.

However, according to this embodiment, the cylindrical shaping air ring 7 provided on the outer periphery of the rotary atomizing head 6 is provided with an overhanging portion 10 as an isolation means for isolating the second shaping air jetting unit 9 from the air flowing around the shaping air ring 7.

Therefore, the overhanging portion 10 can suppress dirt on the front portion of the shaping air ring 7 without having to set aside regular cleaning time during operation, shortening the cleaning interval, lengthening the cleaning time, or providing an automatic cleaning device. As a specific example, it is possible to prevent spray paint from adhering to and staining the front outer cylinder surface 7B. As a result, in this embodiment, the cleaning operation of the shaping air ring 7 can be omitted, thereby improving productivity. In addition, the cost required for cleaning can be reduced.

Moreover, the overhanging portion 10 is provided at the front of the shaping air ring 7 so as to surround the second shaping air jetting unit 9, and is formed in a cylindrical shape extending forward beyond the open end 9B of the second shaping air jetting unit 9. As a result, the overhanging portion 10 surrounding the second shaping air jetting unit 9 can isolate the second shaping air jetting unit 9 from the air convecting to the shaping air ring 7. Therefore, the overhanging portion 10 can prevent the paint particles floating around the shaping air ring 7 from being drawn into the second shaping air jetting unit 9 side.

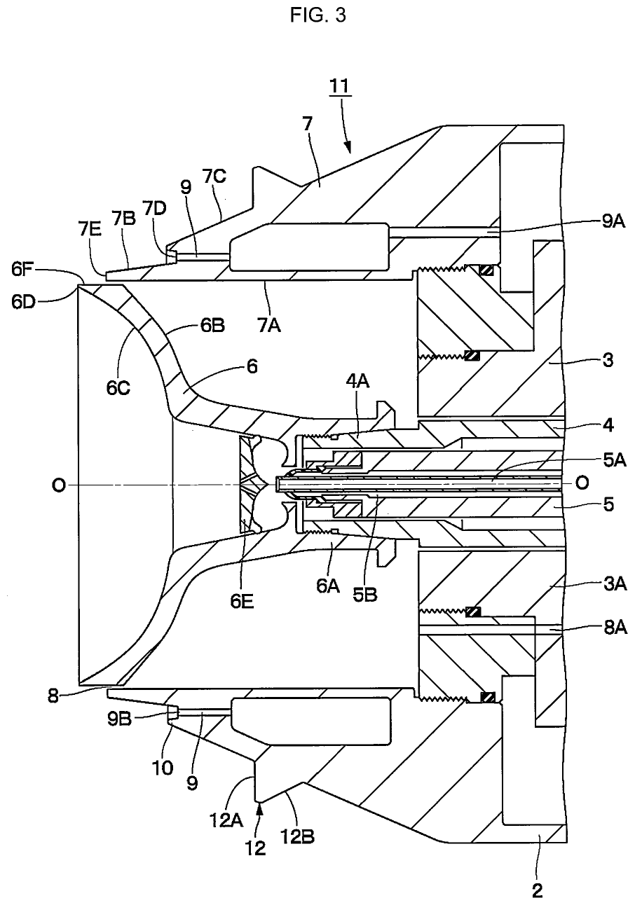

Next, FIG. 3 shows the second embodiment of the present invention. The feature of the second embodiment is that the isolation means is provided at the front of the shaping air ring so as to surround the shaping air outlet, and is composed of a cylindrical eave portion extending forward of the opening end of the shaping air outlet, and an annular flange portion located rearward of the opening end of the shaping air outlet and protruding radially outward from the shaping air ring. In the second embodiment, the same components as those in the first embodiment are denoted by the same reference numerals, and the description thereof will be omitted.

In FIG. 3, a rotary atomizing head type coating machine 11 according to the second embodiment includes a flange unit 12, which will be described later, in addition to the overhanging portion 10 described in the first embodiment, as isolation means.

The flange unit 12 serving as an isolating means is provided on the outer circumferential side of the shaping air ring 7. The flange unit 12, like the overhanging portion 10, serves to isolate the second shaping air jetting unit 9 from the air flowing around the shaping air ring 7.

The flange unit 12 is disposed rearward of the opening end 9B of the second shaping air jetting unit 9, for example, at a position equivalent to the distance from the opening end 9B to the discharge edge 6D of the rotary atomizing head 6. In addition, the flange unit 12 is formed as a circular ring-shaped body that protrudes outward from the rear outer cylinder surface 7C. Specifically, the flange unit 12 is formed into a triangular cross-section by a front surface 12A that expands and extends from the rear outer cylinder surface 7C in a direction perpendicular to the axis, and a tapered peripheral surface 12B that extends from the rear outer cylinder surface 7C a predetermined distance rearward of the front surface 12A toward the periphery of the front surface 12A.◯◯

The circumferential surface 12B is formed as a tapered surface that widens from the rear side to the front side. Therefore, even if the air containing the sprayed paint flows forward along the rear outer cylinder surface 7C by the shaping air, the tapered peripheral surface 12B can direct the sprayed paint away from the second shaping air jetting unit 9. In other words, the flange unit 12 can suppress the paint particles floating around the shaping air ring 7 from being drawn into the second shaping air jetting unit 9 side.

Thus, in the second embodiment thus configured, it is possible to obtain the same functions and effects as in the first embodiment. In particular, in the second embodiment, the isolation means is configured to include a cylindrical eaves portion 10 provided in front of the shaping air ring 7 so as to surround the second shaping air jetting unit 9 and extending forward of the opening end 9B of the second shaping air jetting unit 9, and a circular annular flange unit 12 located rearward of the opening end 9B of the second shaping air jetting unit 9 and protruding radially outward from the shaping air ring 7. Therefore, the two isolating means of the overhanging portion 10 and the flange unit 12 can more reliably suppress contamination of the front portion of the shaping air ring 7.

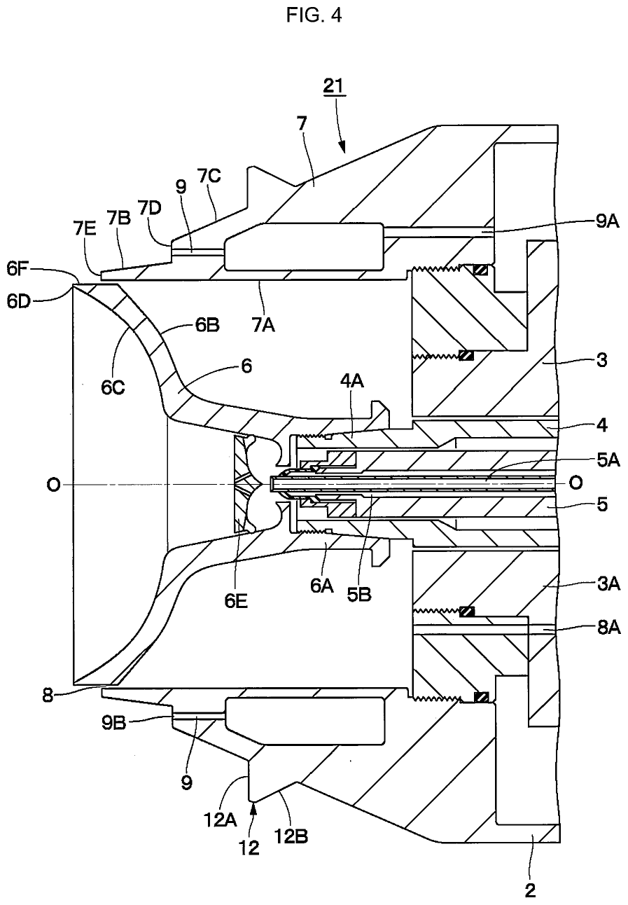

Next, FIG. 4 shows the third embodiment of the present invention. The third embodiment is characterized in that the isolating means is provided only with an annular flange unit located rearward of the open end of the shaping air jetting unit and protruding radially outward from the shaping air ring. In the third embodiment, the same components as those in the second embodiment are denoted by the same reference numerals, and the description thereof will be omitted.

In FIG. 4, a rotary atomizing head type coating machine 21 according to the third embodiment includes only the flange unit 12 described in the second embodiment described above as isolation means.

Thus, the third embodiment configured can also provide the same functions and effects as the previously described embodiments.

In the embodiment, the rotary atomizing head type coating machine 1 has been described by taking as an example a direct charging type electrostatic coater in which a high voltage is directly applied to the paint supplied to the rotary atomizing head 6. However, the present invention is not limited to this, and may also be configured to be applied to an indirect charging type rotary atomizing head type coating machine that has an external electrode that discharges high voltage around the outer periphery of the housing, and applies high voltage to the paint particles sprayed from the rotary atomizing head by discharging from this external electrode. Furthermore, the present invention can also be applied to a non-electrostatic sprayer that performs painting without applying a high voltage to the paint.

### EXPLANATION OF REFERENCES

1, 11, 21 Rotary atomizing head type coating machine
3 Air motor
4 Rotary shaft
4A Front unit
5 Feed tube
6 Rotary atomizing head
6D Discharge edge
7 Shaping air ring
9 Second shaping air jetting unit (shaping air discharge)
9B Opening end
10 Overhanging portion (separation means)
12 Flange unit (separation means)
◯-◯ Axis

1. A rotary atomizing head type coating machine configured with an air motor powered by compressed air, comprising:
a hollow rotating shaft that is rotatably supported in a state of extending in a front-rear direction along an axis of the air motor, the front unit of the rotating shaft protruding from the air motor;
a feed tube extending through the shaft to the front of the shaft;
a cup-shaped rotary atomizing head attached to the front portion of the rotary shaft and discharging the paint supplied from the feed tube from a discharging edge at the front end;
a cylindrical shaping air ring provided on the outer periphery of the rotary atomizing head; and
a shaping air jetting unit provided in front of the shaping air ring and blowing shaping air toward the paint discharged from the discharge edge of the rotary atomizing head,
wherein said shaping air ring is provided with an isolating means for isolating said shaping air jetting unit from air flowing around said shaping air ring.

2. The rotary atomizing head type coating machine according to claim 1,
wherein the isolating means is a cylindrical eaves portion provided at the front unit of the shaping air ring so as to surround the shaping air jetting unit and extending forward beyond an open end of the shaping air jetting unit.

3. The rotary atomizing head type coating machine according to claim 1,
wherein the rotary atomizing head type coating machine, wherein the isolating means is an annular flange located rearward of an open end of the shaping air jetting unit and protruding radially outward from the shaping air ring.
